(19) United States
(12) Patent Application Publication
(10) Pub. No.: US 2012/0158311 A1
(43) Pub. Date: Jun. 21, 2012

(54) APPARATUS FOR REGISTRATION OF TRANSITIONS BETWEEN PSYCHOPHYSIOLOGICAL STATES OF INDIVIDUAL AND METHOD FOR PERFORMING THE SAME

(76) Inventors: Alexander Marcovich Levenstein, Moscow (RU); Vladimir Vikentievich Sukhodoyev, Moscow (RU)

(21) Appl. No.: 13/392,999

(22) PCT Filed: Sep. 29, 2009
(86) PCT No.: PCT/RU2009/000500

§ 371 Date: Feb. 28, 2012

(30) Foreign Application Priority Data
Aug. 31, 2009 (RU) RU2009/000439

(51) Int. Cl. G06F 19/00

(52) U.S. Cl. 702/19

(57) ABSTRACT

The invention relates to a field of medicine and medical devices. An apparatus for registration of transitions between psychophysiological states of individual comprising a reading unit arranged to be capable of measuring an electromotive force under direct electric current of 0.5 to 5.0 microampere to produce a signal; at least two electrodes connected to reading unit, electrodes arranged to be capable of fixing upon the body of individual; a logarithmic unit, quantization unit comprising a comparator arranged to be capable of determining of whether the difference between the current and the previous signal value is greater than N, where N is a predefined value from 0.1 to 2.0 centineper; and a pulse generator arranged to be capable of generating a pulse having an amplitude of N when the difference between the current and the previous signal value is greater than N; the apparatus further comprising a compensating unit, a processing unit capable of monitoring the pulse values; and at least one power supply. A method for registration of psychophysiological state transition of individual comprises the following steps: (a) measuring of electromotive force between electrodes fixed upon the skin of individual under flow of direct current in interval from 0.5 to 5.0 microampere; (b) logarithming of signal; (c) quantizing the logarithm of signal from step (b) by level from 0.1 to 2.0 centineper; and (d) determining a transition between psychophysiological state of the individual either by registering sudden increase of unidirectional signal pulses amount, or by registering a shift in signal level up to 1.5-3.0 fold as compared to initial value.

### FIELD OF THE INVENTION

This invention relates to the field of medicine and medical devices, namely to a method and apparatus for diagnostics of the individual's organism state by measuring skin potential response (SPR).

### BACKGROUND OF THE INVENTION

Psychophysiological state (PPS) influences the ideomotoric reactions and the abilities of individual to process information and to make rapid decisions.

Therefore further improvement of devices and development of methods for registration of transitions from one psychophysiological state to another appears important. These very transitions may essentially influence the labor efficiency, human safety and health. Knowing initial psychophysiological state and registering the transitions from one state to another, one may make valid conclusions upon current psychophysiological state of the individual.

Variety of psychophysiological states of individual includes hyperactivation, activation, relaxation and falling asleep. Two types of transition dynamics are distinguished: first type transition are characterized by sudden and unintentional flow, when individual unconsciously makes transitions from one psychophysiological state to another in a short term (less than 5 minutes), and second type transitions characterizing by gradual development when the changes of PPS are accumulated in the course of activity in a long term (30 minutes and more). The unsatisfied demand for creating universal ways to distinguish first and second type transitions still exists.

Biofeedback apparatus for monitoring skin potential response taught in U.S. Pat. No. 4,088,125 includes electrodes for sensing the skin potential, an amplifier for amplifying the signal and feeding the signal into a pair of variable comparators which provide output when the response exceeds preset upper and lower limits. The outputs, in turn, provide a feedback signal either audio or visual, or to serve as inputs to auxiliary instrumentation. No feedback signal is produced as long as the monitored signal is within the selected limits. The magnitude of the responses may be quantified to the extent that they exceed the preset levels. The apparatus described in '125 requires preliminary measuring of the limits for different individuals in different PFSs.

In a method and an apparatus for registration skin potential response described in USSR Inventor's Certificate No. 1,725,829, a level phase component is measured relative to tonic component of electrodermal activity, extracted by scheme, containing (at the exits of corresponding amplifiers) filters of high and low frequencies, as well as dividing circuit. Since the scales of the measured values in '829 are not transformed to relative values the results of measurements are influenced by individual skin characteristics.

A mobile apparatus for individual state monitoring taught in published U.S. Pat. Application No. 2008/00214903, have means of real-time data collection from one or more sensors placed on the body of individual and means of presenting aforementioned data on mobile device display (phone, notebook, etc.) for self control. As PPS is estimated not by apparatus, but by individual himself based on apparatus measurements the apparatus described in '903 is unsuitable for real-time PPS estimation. This apparatus only informs individual about the sensors measurements.

In a method for registration skin potential response taught in Russian Inv. Pat. No. 2,107,460 two electrodes are placed on the individual's body, electric voltage is applied to electrodes, time variations of electric current between electrodes is registered, current impulses in phase component band of electrodermal activity is recorded, form of each impulse in the sequence of impulses in the phase component band is analyzed (by registering signal as a time derivative of electric current numerical rate logarithm, defining the value of trend, resulting from signal changes in tonic component of electrodermal activity, correction of first derivative value subtracting the value of trend), and first and second time derivatives from logarithm of electric current value.

An apparatus described in '460 comprising electrodes, having means of fixation, which are connected to input unit, means of pulse interference blanking, means of signal extraction from phase component band of electrodermal activity, means of detecting phase component impulses and registration unit, wherein means of signal extraction from phase component band of electrodermal activity, means of detecting phase component impulses implemented as daisy chain to lower frequencies input filter of the incoming signal to first and second time derivative transformation unit and impulse shape analysis unit, wherein the exit of the latter is connected to the input of the registration unit. An apparatus described in '460 can not be utilized by individuals having high skin conductivity, as measuring of electric current with constant voltage requires proportional increase in electric current as skin resistance growths. This may influence to the skin metabolic processes leading to the result distortion.

This apparatus is also requires an etalon samples of individual reactions to be predetermined. The signal processing includes the first and the second derivative calculation of the current value logarithm by using of rather complex arrangement, comprising memory unit and impulse shape analysis unit.

While there is a substantial need for development of a method and apparatus for registration of transitions between individual's psychophysiological states, no simple and reliable method and apparatus has been identified. It is therefore an object of the present invention to provide a method and apparatus for registration of transitions between psychophysiological states of individual.

### SUMMARY OF THE INVENTION

According to the present invention it is provided an apparatus for registration of transitions between psychophysiological states of individual, the apparatus comprising

(a) a reading unit arranged to be capable of measuring an electromotive force under direct electric current of 0.5 to 5.0 microampere to produce a signal;

(b) at least two electrodes connected to said reading unit, said electrodes arranged to be capable of fixing upon the body of individual;

(c) a logarithmic unit arranged to produce a logarithm of signal from reading unit; and

(d) a quantization unit arranged to be capable of quantization of signal by level, said quantization unit comprising

(e) a comparator arranged to be capable of determining of whether the difference between the current and the previous signal value is greater than N, where N is a predefined value from 0.1 to 2.0 centineper; and

(f) a pulse generator arranged to be capable of generating a pulse having an amplitude of N when the difference between the current and the previous signal value is greater than N;

wherein the apparatus further comprising

(g) a compensating unit arranged to be capable of correcting the signal value from logarithmic unit by the pulse value from pulse generator to produce corrected signal, and supplying corrected signal to said comparator;

(h) a processing unit capable of monitoring the pulse values; and

(i) at least one power supply.

According to another aspect of present invention it is provided a method for registration of psychophysiological state transition of individual, comprising the following steps:

(a) measuring of electromotive force between electrodes fixed upon the skin of individual under flow of direct current in interval from 0.5 to 5.0 microampere;

(b) logarithming of signal is taken in step (a);

(c) quantizing the logarithm of signal from step (b) by level from 0.1 to 2.0 centineper; and

(d) determining a transition between psychophysiological state of the individual either by registering sudden increase of unidirectional signal pulses amount, or by registering a shift in signal level up to 1.5-3.0 fold as compared to initial value.

Technical effect of present invention is the increase in informational content of SPR signal, improved reliability of PPS transition registration and simplification of preliminary definition of allowance for individual skin features.

### BRIEF DESCRIPTION OF DRAWINGS

FIG. 1 is a block diagram of the particular embodiment according to present invention.

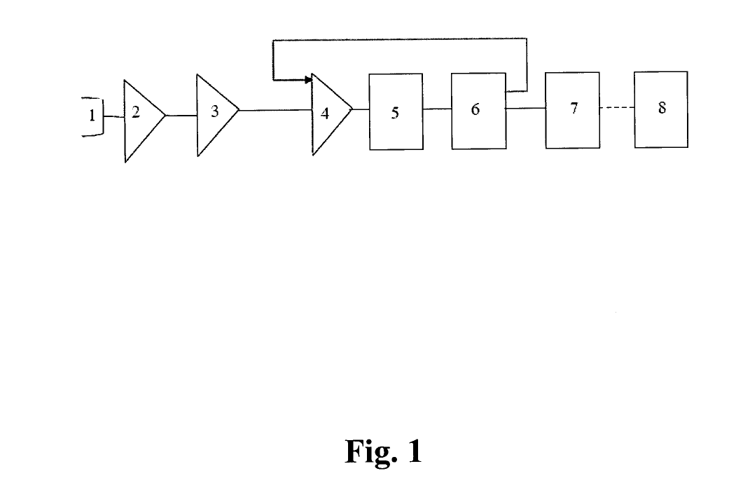

FIG. 2 is a block diagram of the transition registration method. Beginning (10). Initial values setup (11). Measurements (12) by units (1-2). Signal processing (13) in units (3-5). If condition (14): <<is there a signal from pulse generator (6)?>> is not satisfied, then measurement continue (12), else if condition (15) <<does level of signal change with maximal speed 2 seconds?>> or condition (16) <<does level of signal differ from initial more then 1.5 fold?>> satisfied, then the program of reaction to PPS state of subject is used (17), else measurements continue (12).

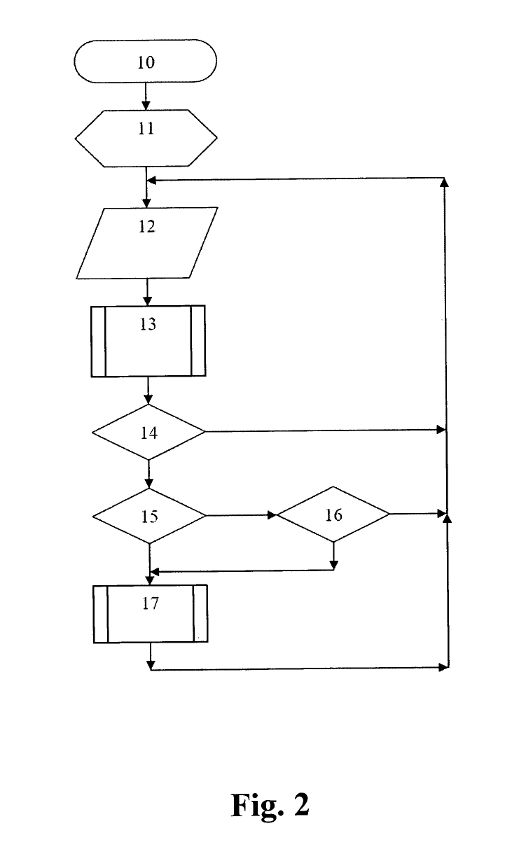

### DETAILED DESCRIPTION OF THE INVENTION

Therefore the object matter of presented patent is acquisition of SPR signal, upon which reliable conclusions about individual psychophysiological state could be drawn without tedious preliminary adjustments to individual skin features, and reactions of the apparatus on the appearance of states critical for individual could be formed. The present invention is applicable for registration of said first type and second type transitional states.

As stated above, technical effect of present invention is the increase in informational content of SPR signal, improved reliability of PPS transition registration and simplification of preliminary adjusting to individual skin features.

Technical effect is achieved due to design of an apparatus for registration of transitions between psychophysiological states of individual, comprising

(a) a reading unit arranged to be capable of measuring an electromotive force under direct electric current of 0.5 to 5.0 microampere to produce a signal;

(b) at least two electrodes connected to said reading unit, said electrodes arranged to be capable of fixing upon the body of individual;

(c) a logarithmic unit arranged to produce a logarithm of signal from reading unit; and

(d) a quantization unit arranged to be capable of quantization of signal by level, said quantization unit comprising

(e) a comparator arranged to be capable of determining of whether the difference between the current and the previous signal value is greater than N, where N is a predefined value from 0.1 to 2.0 centineper; and

(f) a pulse generator arranged to be capable of generating a pulse having an amplitude of N when the difference between the current and the previous signal value is greater than N;

the apparatus further comprising

(g) a compensating unit arranged to be capable of correcting the signal value from logarithmic unit by the pulse value from pulse generator to produce corrected signal, and supplying corrected signal to said comparator;

(h) a processing unit capable of monitoring the pulse values; and

(i) at least one power supply.

In a particular embodiment, the apparatus further comprising (j) a signal transmitting unit, wherein said reading unit have an output and said logarithmic unit have an input connected thereto; said logarithmic unit have an output and said compensating unit have a first input connected thereto; said comparator have an output and said pulse generator have an input connected thereto; said pulse generator have a first output and said signal transmitting unit have an input connected thereto; said pulse generator have a second output and said compensating unit have a second input connected thereto; said transmitting unit have an output and said processing unit have an input connected thereto.

In one particular embodiment, the apparatus further comprising (k) a control unit having a thermometer, said control unit is capable of controlling a reliability of registration.

In another particular embodiment, said electrodes is in the form of rings for fingers of one hand, and its body frame is in the form of a crossbar with said rings connected thereto.

Such an apparatus may be implemented, for instance, as double ring with contacts on the palm sides of the fingers, wherein the crossbar between the rings accommodates power unit, logarithmic amplifier, quantization unit and signal transmission unit (all those implemented as one or several microchips). Signal transmission unit may be implemented as galvanic decoupler, which may be implemented as Bluetooth microchip or any other transmitting device, compatible with receiving unit of the processing center. Combination of processing center and detector in one physical unit is also possible.

In another particular embodiment, the apparatus further comprising glove to put on hand of individual with said electrodes accommodated therein.

In a particular embodiment, the apparatus further comprising (l) radio transmitter unit and (m) data receiving unit connected to said processing unit, wherein said radio transmitter unit and said receiving unit are connected by wireless communication channel thereby enabling data exchange therebetween.

In one particular embodiment, the apparatus further comprising (l) radio transmitter unit and (m) data receiving unit connected to said processing unit, wherein said radio transmitter unit and said receiving unit are connected by wireless or wired communication channel thereby enabling data exchange therebetween.

In a preferred embodiment said processing unit is a mobile communication device, a mobile phone, a cellular phone, a communicator or a smartphone.

In another preferred embodiment said processing unit is an automobile onboard computer.

In another preferred embodiment said processing unit is a computer, a desktop computer, a mobile computer or a pocket computer.

In another particular embodiment the apparatus further comprising (n) recording means capable of recording the results.

In another particular embodiment the apparatus further comprising an (o) executive unit capable of affecting at least one sense organ of individual.

In a preferred embodiment said executive unit is arranged to be capable of affecting of at least one sense organ of individual by sound, light, vibration and/or odor.

In particular embodiment, the apparatus further comprising (o) an executive unit affecting individual's sense organs, accommodated in said processing unit or connected thereto.

In another particular embodiment said power supply is connected by a conductor to said processing unit.

In another particular embodiment said power supply is accommodated in said processing unit.

In another particular embodiment, the apparatus further comprising at least one unit arranged to be capable of creating of alternating magnetic field, which is accommodated in said power supply, and at least one unit capable of generating electromotive force induced by said magnetic field.

In a particular embodiment, the apparatus further comprising at least one unit arranged to be capable of creating of alternating magnetic field and at least two unit capable of generating electromotive force induced by said magnetic field, wherein at least one of those units is accommodated in said transmitting unit and the others is accommodated in said processing unit.

In another particular embodiment at least two of said logarithmic unit, said compensating unit, said quantization unit, said transmitting unit, said processing unit, said executive unit and said power supply are accommodated in one body.

In another aspect, a method for registration of psychophysiological state transition of individual provided, the method comprising the following steps:

(a) measuring of electromotive force between electrodes fixed upon the skin of individual under flow of direct current in interval from 0.5 to 5.0 microampere;

(b) logarithming of signal is taken in step (a);

(c) quantizing the logarithm of signal from step (b) by level from 0.1 to 2.0 centineper; and

(d) determining a transition between psychophysiological state of the individual either by registering sudden increase of unidirectional signal pulses amount, or by registering a shift in signal level up to 1.5-3.0 fold as compared to initial value.

According to present method two electrodes are fixed upon individual's body. Preferred signal registration zones are skin areas with increased concentration of nerve endings, particularly palm sides of the fingers. Minimal flow of direct current is applied to electrodes (1), preferably from 0.5 to 5.0 microampere, especially preferable is 2.0 microampere current. Signal (emf) is measured with reading unit (2), with acquisition of continuous analogous signal E. In logarithmic unit (3) logarithm of signal is taken and transformed into digital form, thereby acquiring reading of signal logarithm:
lnE₁, lnE₂, . . . , lnEᵢ₋₁, lnEᵢ

where lnEᵢ—value of signal logarithm at temporal value i. Preferred signal readings discretization period is from 0.01 to 0.5 sec.

After that readings of signal logarithm are quantized in quantization unit (5-6) acquiring a range of impulses R:
R₁, R₂, . . . , Rᵢ₋₁, Rᵢ

For this purpose corrections Q are brought in signal logarithm at the output of logarithmic unit (3). Corrections Q represent accumulated value of signal logarithm on the previous apparatus cycle:
Q₁, Q₂, . . . , Qᵢ₋₁, Qᵢ

and current R is given to the input of comparator (5). In the comparator (5) current R value is compared to quantization level, and if its value difference exceeds the value of N (discretization of level quantization), then pulse generator (6) gives an impulse of the corresponding sign. Thereby, if |lnEᵢ−Qᵢ₋₁|<N, then Rᵢ=0, else if lnEᵢ−Qᵢ₋₁>N, then Rᵢ=N, else if Qᵢ₋₁−lnEᵢ<N, then Rᵢ=−N, at that N is prematurely set and represents the value from the range from 0.25 to 2.0 centineper, depending on the goal of the investigation.

After that the frequency of the unidirectional impulses is calculated. Transitional state of the first type is registered in case of the high frequency of the unidirectional impulses during two seconds (positive impulses—transition into more active state, negative—into less active). Otherwise, if the signal level changes 1.5-3 fold comparing to initial value in the course of a longer time period, then the transitional state of the second type is registered. Certain level of transition is defined through routine experiments, taking into account the individual's specific speed of the signal alteration during excitation or relaxation. Speed of the signal alteration is defined during the experiment.

To acquire initial measurements state signal level in the range from 150 to 600 centineper is achieved (range for the activation state, defined empirically), to do so individual is proposed to do some actions, directed to stable standing in activation state. Considerably wide value range for the activation state is due to individual skin characteristics of different subjects. As far as this level might vary for the same individual depending on many factors (season and health) tuning is done every time current method or apparatus is applied.

Advantage of the present method is that tuning for individual parameters if a subject is reduced to simple operations and takes not more then two minutes.

It is understood that any and all embodiments of the present invention may be taken in conjunction with any other embodiment to describe additional embodiments of the present invention. Furthermore, any elements of an embodiment are meant to be combined with any and all other elements from any of the embodiments to describe additional embodiments. It is understood by those skilled in the art that only combinations of substituents that are workable are an embodiment of the invention.

Signal level quantization allows reduction of noise, due to specialties of the measurements methods, and disturbances due to subject activities. Therefore utilization of the present invention allows to increase the reliability of the operational esteem of the individual psychophysiological state during his activity and makes it possible to register PPS dangerous for individual.

The present invention may be used for control or self-control of the psychophysiological state, especially in the course of activity, demanding high attention concentrating, particularly, when driving automobiles, as well as for registration decrease in attention and decline of reaction. Present invention could be also used in medical research for patients state monitoring.

### DESCRIPTION OF THE PREFERRED EMBODIMENTS

Following examples are given for illustration of inventor's idea. Nothing in the present section should be interpreted as limitation of bounds of invention. It should be clear, that average specialist acquainted with the ideas of present invention may use its main differential characteristics and introduce equivalent substitutions with acquisition of stated goal and non confronting the spirit and area of the present invention.

In one of the preferred embodiments apparatus has two electrodes (1), electrodes are connected to first and second input of the reading unit (2). Output of the reading unit (2) output of the reading unit is connected to input of logarithmic unit (3), output of logarithmic unit is connected to first input of compensating unit (4), output of compensating unit is connected to the input comparator (5), which is a constitutive part of the of the quantization unit together with pulse generator (6). Output of comparator (5) is connected to input of pulse generator (6). First output of pulse generator (6) is connected to second input of compensating unit (4), second output of pulse generator is connected to input of signal transmitting unit (7). Output of transmitting unit (7) is connected to input of processing unit (8).

In a particular embodiment processing unit (8) is implemented as constructively separated, connected to the rest of the apparatus by communication channel (wired or wireless), or might be implemented in one body with the rest of apparatus.

In one embodiment output of the processing unit (8) is connected to input of execution unit.

Apparatus works as follows: reading unit (2) providing the direct current flow in the range from 0.5 to 5 microampere through the electrodes fixed upon the subject skin (1), measures the ems and gives the signal to the input of the logarithmic unit (3). Logarithmic unit (3) gives the signal logarithm to the input of compensating unit (4). Compensating unit (4) alters the input signal by the current value of the correction Q and gives the signal to the input of comparator (5). Comparator (5) compares the current signal to its previous value and if the difference exceeds the preliminary set signal quantization level N (preferably chosen from the range from 0.1 to 2 centineper), then it gives the signal to the input of the pulse generator (6). Given the signal on the input pulse generator (6) produces on its first and second outputs signal of preliminary set absolute value, sign of which depends on the difference of signals in comparator. Given the signal on the second input of the compensating unit (4), correction Q alters by the preliminary set value of the level quantization discretization N (which may be both positive and negative). Signal from the second output of the pulse generator (6) goes to the input of the transmitting unit (7). Transmitting unit (7) transmits the signal to the processing unit (8), preferably by means of radio channel. Impulses are transmitted to the processing unit with preferable period from 1 to 1000 msec, especially preferable is the period of 100 msec.

In one of the preferable embodiments in case the PPS transition state is detected, the transmitting unit (8) gives the signal to execution unit (9). At that execution unit (9) affect the sensual organs of individual.

For research purposes the processing unit may contain a program of signal processing and result registration on the storing device, as well as means of synchronization of affect on the subjects and measurements registration.

To set up the initial correction Q (i.e. initial signal logarithm), apparatus is connected to individual, positive impulses are successively accumulated and averaged to reach the constant average value. Time to set the initial signal value according to calculations and experience in signal measurements is preferably from one to two minutes. To shorten the setting up time one may use the direct transmission of the first acquired value for the signal logarithm to the processing center, followed by correction by acquired impulses. In this case time of initial set up may be shortened to 10 seconds.

To control the reliability of the measurements, in one of the embodiments, apparatus additionally contains control unit, equipped with temperature meter (body temperature influences the characteristics of skin conduction). Temperature is acquired every two minutes with discretization of 0.1 degree and error +/−0.2 degrees in the range of temperatures measured (from 10 to 42 degrees).

Apparatus is characterized by high quality of diagnostics for the transitional states of individual without long time procedure of individual tuning; possibility of subject PPS estimation already after 2 minutes after the measurements started (which provides wide range of possible application for apparatus, from house hold device to operative medical diagnostics); absence of the device influences on the subject distorting the measurements and due to that achievement of high reliability of results; simple scheme of apparatus implementation, providing cost effectiveness in production and operation.

Changes and modifications of the described apparatus, as well as additional applications of the present invention principles, evident for the specialist in the current pertinent art, are included in the scope of present invention.

1. An apparatus for registration of transitions between psychophysiological states of an individual, the apparatus comprising:
a reading unit arranged to be capable of measuring an electromotive force under direct electric current of 0.5 to 5.0 microampere to produce a signal;
at least two electrodes connected to said reading unit, said electrodes being arranged to be capable of fixing upon the body of the individual;
a logarithmic unit arranged to produce a logarithm of the signal from said reading unit;
a quantization unit arranged to be capable of quantization of signal by level, said quantization unit comprising:
a comparator arranged to be capable of determining of whether a difference between a current signal value and a previous signal value is greater than N, where N is a predefined value from 0.1 to 2.0 centineper; and
a pulse generator arranged to be capable of generating a pulse having an amplitude of N when the difference between the current signal value and the previous signal value is greater than N;
a compensating unit arranged to be capable of correcting the signal value from said logarithmic unit by the pulse value from said pulse generator to produce a corrected signal, and supplying said corrected signal to said comparator;
a processing unit capable of monitoring the pulse values; and
at least one power supply.

2. An apparatus according to claim 1, further comprising:
a signal transmitting unit, wherein said reading unit has an output and said logarithmic unit has an input connected to said output of said reading unit, said logarithmic unit having an output and said compensating unit having a first input connected to said output of said logarithmic unit, said comparator having an output and said pulse generator having an input connected to said output of said comparator, said pulse generator having a first output and said signal transmitting unit having an input connected to said first output of said pulse generator, said pulse generator having a second output and said compensating unit having a second input connected to said second output, said signal transmitting unit having an output and said processing unit having an input connected to said output of said signal transmitting unit.

3. An apparatus according to claim 1, further comprising:
a control unit having a thermometer, said control unit being capable of controlling a reliability of registration.

4. An apparatus according to claim 1, wherein said electrodes is in the form of rings for fingers of one hand, and a body frame is in a form of a crossbar with said rings affixed thereto.

5. An apparatus according to claim 1, further comprising:
a glove to put on a hand of the individual with said electrodes accommodated therein.

6. An apparatus according to claim 1, further comprising:
a radio transmitter unit and a data receiving unit connected to said processing unit, wherein said radio transmitter unit and said receiving unit are connected by a wireless communication channel thereby enabling data exchange between said radio transmitter unit and said receiving unit.

7. An apparatus according to claim 1, further comprising:
a radio transmitter unit and a data receiving unit connected to said processing unit, wherein said radio transmitter unit and said receiving unit are connected by one of wireless communication and a wired communication channel thereby enabling data exchange between said radio transmitter unit and said data receiving unit.

8. An apparatus according to claim 7, wherein said processing unit is one of a mobile communication device, a mobile phone, a cellular phone, a communicator and a smartphone.

9. An apparatus according to claim 7, wherein said processing unit is an automobile onboard computer.

10. An apparatus according to claim 7, wherein said processing unit is one of a computer, a desktop computer, a mobile computer and a pocket computer.

11. An apparatus according to claim 1, further comprising:
a recording means for recording the results.

12. An apparatus according to claim 1, further comprising:
an executive unit capable of affecting at least one sense organ of the individual.

13. An apparatus according to claim 12, wherein said executive unit is arranged to be capable of affecting of at least one sense organ of the individual by one or more of sound, light, vibration and odor.

14. An apparatus according to claim 6, further comprising:
an executive unit affecting sense organs of the individual, said executive unit being one of accommodated in said processing unit and connected to said processing unit.

15. An apparatus according to claim 7, wherein said power supply is connected by a conductor to said processing unit.

16. An apparatus according to claim 7, wherein said power supply is accommodated in said processing unit.

17. An apparatus according to claim 1, further comprising:
at least one unit arranged to be capable of creating of an alternating magnetic field, said at least one unit being accommodated in said power supply, and at least one unit capable of generating an electromotive force induced by said magnetic field.

18. An apparatus according to claim 1, further comprising:
at least one unit arranged to be capable of creating of an alternating magnetic field and at least a second unit capable of generating an electromotive force induced by said magnetic field, wherein at least one of said at least one unit and said at least said second unit is accommodated in said transmitting unit and another one of said at least one unit and said at least said second unit is accommodated in said processing unit.

19. An apparatus according to claim 1, wherein at least two of said logarithmic unit, said compensating unit, said quantization unit, said transmitting unit, said processing unit, said executive unit and said power supply are accommodated in one body.

20. A method for registration of a psychophysiological state transition of an individual, the method comprising the following steps:
(a) measuring an electromotive force between electrodes fixed upon the skin of the individual under a flow of direct current from 0.5 to 5.0 microampere;
(b) logarithming of a signal taken in step (a);
(c) quantizing the logarithm of the signal from step (b) by level from 0.1 to 2.0 centineper; and
(d) determining a transition between a psychophysiological state of the individual by one of registering sudden increase of unidirectional signal pulses amount and by registering a shift in signal level up to 1.5-3.0 fold as compared to an initial value.
